(19) United States
(12) Patent Application Publication
(10) Pub. No.: US 2013/0106077 A1
(43) Pub. Date: May 2, 2013

(54) WHEELCHAIR PULL STRAP

(71) Applicant: Joan M. Nagel, Cape Coral, FL (US)

(72) Inventor: Joan M. Nagel, Cape Coral, FL (US)

(21) Appl. No.: 13/285,068

(22) Filed: Oct. 31, 2011

(51) Int. Cl. B60D 1/18

(52) U.S. Cl. 280/480

(57) ABSTRACT

A wheelchair pull strap (1) for pulling a wheelchair (2) behind a walking patient (20) in case the patient needs to sit. A first strap (3) and a second strap (4) having proximal ends (6) and distal ends (7) attached to rear corners (9) of a wheelchair seat (10) at the proximal ends. A loop (13) is located on the distal ends of the first strap and the distal end of the second strap. When the wheelchair pull strap is attached to the wheel chair and pulled in a forward direction, it forms a V shape, thereby applying equal force to each side of the wheelchair so the wheelchair follows behind the patient. The loop of the wheelchair pull strap is preferably attached to an arm or hand of a caregiver (22) while assisting the patient to walk.

### BACKGROUND OF THE INVENTION

This invention relates to the use of wheelchairs for patients undergoing rehabilitation treatment and more particularly to a pull strap that allows a caregiver to assist a patient with walking while pulling a wheelchair behind the patient in case the patient needs to sit or falls backward.

Many patients confined to wheelchairs after surgery, strokes, accidents, joint replacements and so forth are required to undergo physical therapy to learn to stand and walk again. Ideally, this requires one caregiver to assist the patient with standing and walking and a second caregiver the push a wheelchair behind the patient in case the patient needs to sit down. This is costly due to the fact that two caregivers are needed to assist the patient. However, if a second caregiver is not available, then the first caregiver must keep one hand on the patient and the other hand on the wheelchair or drag the wheelchair with his or her foot behind the patient, thus creating a dangerous situation because the caregiver does not have a solid hold on the patient.

Therefore, a need exists for a device that will allow a caregiver to pull a wheelchair behind the patient while still maintaining a solid hold on the patient, thereby eliminating the need for the second caregiver to push the wheelchair behind the patient.

The relevant prior art includes the following references:

| Patent No. | | |
|---|---|---|
| (U.S. Patent References) | Inventor | Issue/Publication Date |
| 2011/0006494 | Walker | Jan. 13, 2011 |
| 7,500,689 | Pasternak et al. | Mar. 10, 2009 |
| 7,216,728 | Huang et al. | May 15, 2007 |
| 6,702,313 | Forshee et al. | Mar. 09, 2004 |
| D407,347 | Gallandat | Mar. 30, 1999 |
| 5,826,670 | Nan | Oct. 27, 1998 |
| 5,470,093 | Kiser | Nov. 28, 1995 |
| 5,451,193 | Pickard | Sep. 19, 1995 |
| 5,350,184 | Hull et al. | Sep. 27, 1994 |
| 4,671,522 | Fragione, Jr. | Jun. 09, 1987 |
| 1,327,864 | Everingham | Jan. 13, 1920 |

### SUMMARY OF THE INVENTION

The primary object of the present invention is to provide a wheelchair pull strap so that a caregiver or patient can to pull a wheelchair behind the patient.

An additional object of the present invention is to provide a wheelchair pull strap that eliminates the need for a second caregiver to push a wheelchair behind a patient who is learning to walk.

The present invention fulfills the above and other objects by providing a wheelchair pull strap having a first strap and a second strap, each having proximal and distal ends. The proximal ends are attached to rear corners of a wheelchair seat or integrated into the rear corners of the wheelchair seat. A loop is located on the distal ends of the first strap and the second strap. When the wheelchair pull strap is attached to the wheel chair and pulled in a forward direction, it forms a V shape, thereby applying equal force to each side of the wheelchair so the wheelchair travels in a straight line behind a patient, thereby ensuring the wheelchair is always behind the patient in case the patient needs to sit.

The loop of the wheelchair pull strap is preferably attached to an arm or hand of a caregiver while assisting a patient to walk, thereby eliminating the need for a second caregiver to push the wheelchair behind the patient

The above and other objects, features and advantages of the present invention should become even more readily apparent to those skilled in the art upon a reading of the following detailed description in conjunction with the drawings wherein there is shown and described illustrative embodiments of the invention.

### BRIEF DESCRIPTION OF THE DRAWINGS

In the following detailed description, reference will be made to the attached drawings in which:

FIG. 1 is a front view of a wheelchair pull strap of the present invention;

FIG. 2 is a perspective view of a wheelchair having a wheelchair pull strap of the present invention attached thereto;

FIG. 3 is a rear view of a wheelchair having a wheelchair pull strap of the present invention attached thereto; and

FIG. 4 is a side view of a wheelchair having a wheelchair pull strap of the present invention attached thereto and being pulled by a caregiver.

### DESCRIPTION OF THE PREFERRED EMBODIMENTS

For purposes of describing the preferred embodiment, the terminology used in reference to the numbered accessories in the drawings is as follows:
1. wheelchair pull strap
2. wheelchair
3. first strap
4. second strap
5. distal end
6. proximal end
7. upper surface
8. lower surface
9. rear corner
10. wheelchair seat
11. attachment means
12. clip
13. loop
14. center line
15. first end
16. second end
17. hook and loop fastener
18. adjustment means
19. sliding clip
20. rear surface
21. back of wheelchair
22. care giver
23. patient
24. gait belt

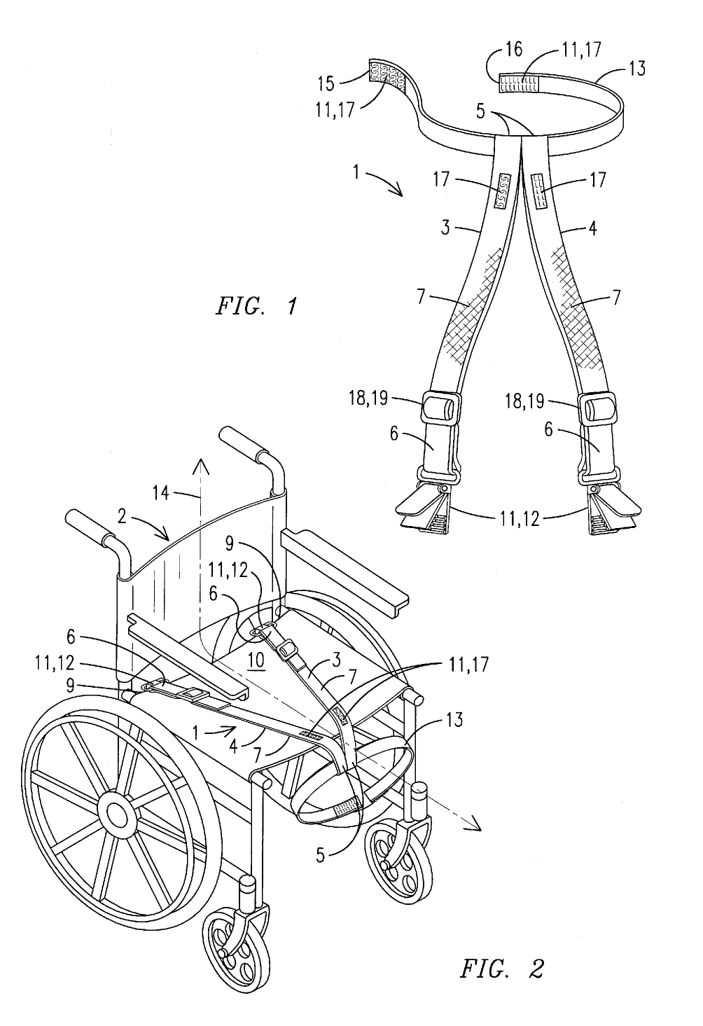

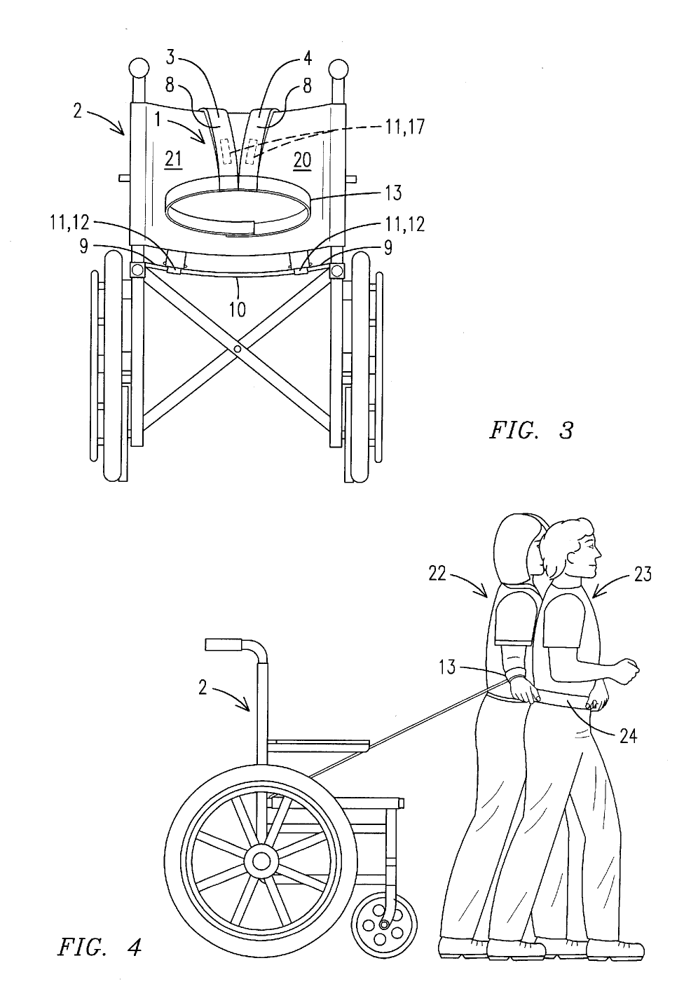

With reference to FIGS. 1, 2 and 3, a front view of a wheelchair pull strap 1 of the present invention, a perspective view of a wheelchair 2 having a wheelchair pull strap 1 of the present invention attached thereto and a rear view of a wheelchair 2 having a wheelchair pull strap 1 of the present invention attached thereto, respectively, are illustrated. The wheelchair pull strap 1 comprises a first strap 3 and a second strap 4 each having distal ends 5, proximal ends 6, upper surfaces 7 and lower surface 8. The proximal ends 6 are attached to rear corners 9 of a wheelchair seat 10 via an attachment means 11, such as clips 12, hooks, hook and loop fastener, snaps, sewing, rivets, screws and so forth. A loop 13 is located on the distal ends 5 of the first strap 3 and the second strap 4. When the wheelchair pull strap 1 is attached to the wheel chair 2, the loop 13 rests on a center line 14 of the wheelchair seat 10 and the first strap 3 and second strap 4 extend from the loop 13 at angles to the rear corners 9 of the wheelchair seat 10, thereby forming a V shape allowing a user to apply equal force to each side of the wheelchair 2 while pulling the loop 13 in a forward direction. The loop 13 preferably has a first end 15 and a second end 16 that are attachable to each other via an attachment means 11, such as hook and loop fastener 17, sliding clips, sliding buckle clips, snaps and so forth. The first end 15 and second end 16 allow a user to attach the loop 13 to a gait belt 23 (as shown in FIG. 4) and/or adjust the diameter of the loop 13. The first strap 3 and second strap 4 may also be adjustable in length via an adjustment means 18, such as hook and loop fastener, sliding clips 19, sliding buckle clips and so forth. An attachment means 11, such as hook and loop fastener 17, snaps and so forth, may also may be located on the upper surfaces 7 of the first strap 3 and second strap 4 as well as a rear surface 20 of a back 21 of the wheel chair 2, thereby allowing a user to store the wheelchair pull strap 1 while not in use by draping the wheelchair pull strap 1 over the back 21 of the wheel chair 2 and attaching it the rear surface 20 of a back 21 of the wheel chair 2 using the hook and loop fastener.

With reference to FIG. 4, a side view of a wheelchair 2 having a wheelchair pull strap 1 of the present invention attached thereto and being pulled by a caregiver 22 assisting a patient 23 is illustrated. A caregiver 22 normally assists a patient 23 to walk by placing a hand on the patient's back or by holding a gait belt 24. The caregiver 22 preferably places the loop 13 around his or her wrist or pulls the loop 13 with his or her hand while assisting the patient 23 to walk. The wheelchair pull strap 1 ensures that the wheelchair 2 is always behind the patient 23 in case the patient 23 needs to sit, thereby eliminating the need for a second caregiver to push the wheelchair 2 behind the patient 23.

It is to be understood that while a preferred embodiment of the invention is illustrated, it is not to be limited to the specific form or arrangement of parts herein described and shown. It will be apparent to those skilled in the art that various changes may be made without departing from the scope of the invention and the invention is not to be considered limited to what is shown and described in the specification and drawings.

Having thus described my invention, I claim:

1. A wheelchair pull strap that allows a wheelchair to be pulled forward in behind a patient, thereby ensuring the wheelchair is always behind the patient in case the patient needs to sit, said wheelchair pull strap comprising:
a loop for attaching the wheelchair pull strap to a person;
a first strap having an upper surface, lower surface, proximal end and a distal end;
said distal end of the first strap is attached to the loop;
a second strap having an upper surface, lower surface, proximal end and a distal end;
said distal end of the second strap is attached to the loop;
an attachment means located at the proximal end of said first strap for attaching the first strap to a rear corner of a wheelchair seat; and
an attachment means located at the proximal end of said first strap for attaching the proximal end of the second strap to a rear corner located on an opposite side of the wheelchair seat.

2. The wheelchair pull strap of claim 1 further comprising:
said first strap and second strap extend from the loop to create a V shape.

3. The wheelchair pull strap of claim 1 wherein:
said loop further comprises a first end and a second end attachable to each other via an attachment means.

4. The wheelchair pull strap of claim 1 further comprising:
an adjustment means located on the first strap for adjusting the length of the first strap; and
an adjustment means located on the second strap for adjusting the length of the second strap.

5. The wheelchair pull strap of claim 1 further comprising:
an attachment means located on the front surface of the first strap;
an attachment means located on the front surface of the second strap; and
an attachment means located on a rear surface of a back of the wheelchair for attaching the front surface of the first strap and the front surface of the second strap to the back of the wheelchair.

6. A wheelchair pull strap that allows a wheelchair to be pulled forward in a straight line behind a patient, thereby ensuring the wheelchair is always behind the patient in case the patient needs to sit, said wheelchair pull strap comprising:
a loop for attaching the wheelchair pull strap to a person;
a first strap having an upper surface, lower surface, proximal end and a distal end;
said distal end of the first strap is attached to the loop;
a second strap having an upper surface, lower surface, proximal end and a distal end;
said distal end of the second strap is attached to the loop;
said first strap and second strap extend from the loop to create a V shape;
an attachment means located at the proximal end of said first strap for attaching the first strap to a rear corner of a wheelchair seat; and
an attachment means located at the proximal end of said first strap for attaching the proximal end of the second strap to a rear corner located on an opposite side of the wheelchair seat.

7. The wheelchair pull strap of claim 6 wherein:
said loop further comprises a first end and a second end attachable to each other via an attachment means.

8. The wheelchair pull strap of claim 6 further comprising:
an adjustment means located on the first strap for adjusting the length of the first strap; and
an adjustment means located on the second strap for adjusting the length of the second strap.

9. The wheelchair pull strap of claim 6 further comprising:
an attachment means located on the front surface of the first strap;
an attachment means located on the front surface of the second strap; and
an attachment means located on a rear surface of a back of the wheelchair for attaching the front surface of the first strap and the front surface of the second strap to the back of the wheelchair.

10. A wheelchair pull strap that allows a wheelchair to be pulled forward in a straight line behind a patient, thereby ensuring the wheelchair is always behind the patient in case the patient needs to sit, said wheelchair pull strap comprising:
a loop for attaching the wheelchair pull strap to a person;
said loop having a first end and a second end attachable to each other via an attachment means;
a first strap having an upper surface, lower surface, proximal end and a distal end;
said distal end of the first strap is attached to the loop;
a second strap having an upper surface, lower surface, proximal end and a distal end;
said distal end of the second strap is attached to the loop;
said first strap and second strap extend from the loop to create a V shape;
an attachment means located at the proximal end of said first strap for attaching the first strap to a rear corner of a wheelchair seat; and
an attachment means located at the proximal end of said first strap for attaching the proximal end of the second strap to a rear corner located on an opposite side of the wheelchair seat.

11. The wheelchair pull strap of claim 10 further comprising:
an adjustment means located on the first strap for adjusting the length of the first strap; and
an adjustment means located on the second strap for adjusting the length of the second strap.

12. The wheelchair pull strap of claim 10 further comprising:
an attachment means located on the front surface of the first strap;
an attachment means located on the front surface of the second strap; and
an attachment means located on a rear surface of a back of the wheelchair for attaching the front surface of the first strap and the front surface of the second strap to the back of the wheelchair.
